(19) United States
(12) Patent Application Publication
(10) Pub. No.: US 2005/0199412 A1
(43) Pub. Date: Sep. 15, 2005

(54) Cable

(76) Inventors: Yun Long Ke, Tu-chen (TW); Chin Pao Kuo, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/025,186

(22) Filed: Dec. 28, 2004

(30) Foreign Application Priority Data
Mar. 9, 2004 (TW) 93106162

(51) Int. Cl. H01B 7/29

(52) U.S. Cl. 174/108

(57) ABSTRACT

A cable includes a number of conductive wires arranged loosely from one another and an elongate protecting sheet surrounding the number of conductive wires such that the conductive wires are free to move with respect to each other when the cable are bent. The protecting sheet has at least an adhesive strip along the sheet. When the protecting sheet is helically wrapped along the conductive wires, the conductive wires are untouched by the adhesive strip.

### BACKGROUND OF THE INVENTION

1. Field of the Invention

The present invention relates to a cable, and in particular to a cable employed in a laptop computer or other like devices.

2. Description of the Prior Art or Related Art

A laptop computer comprises a host and an LCD (Liquid Crystal Display) monitor linked with each other via a hinge. The host electrically connects to the monitor by a cable with a pair of connectors mounted on opposite ends thereof. The cable normally extends in the inner space of the host and then passes through the hinge into the monitor. The cable may comprise a plurality of wires (for example, micro-coaxial wires) that are flexible but cannot bear of fairly pulling force. Referring to FIG. 1, to provide protection for wires 2′, a sheet 3′ having an adhesive inner surface 4′ is used to helically surround the wires 2′. However, because the inner surface 4′ is substantially coated with adhesive material, during opening the laptop computer, an outer surface of the sheet maybe stagnated by a protruding of the hinge or the host, which results that the wires cannot extend freely because the wires have been adhesive to the sheet. So the wires may be damaged after quiet a number of times of opening and closing the laptop computer.

Hence, an improved cable is desired to overcome the above-mentioned disadvantages of the prior and related arts.

### BRIEF SUMMARY OF THE INVENTION

A primary object of the present invention is to provide a cable having a protecting sheet surrounding a plurality of wires therein.

A cable comprises a plurality of conductive wires arranged loosely from one another and a protecting sheet surrounding the plurality of conductive wires such that the conductive wires are movable with respect to each other when the cable are bent. The protecting sheet configured by an elongate sheet has at least an adhesive strip along the sheet. When the sheet is wrapped along the conductive wires, the conductive wires are untouched by the adhesive strip.

Still another objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top view of a traditional cable.

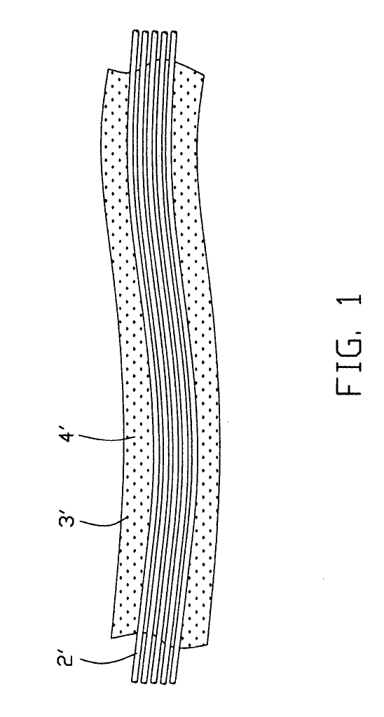

FIG. 2 is a top view of a cable in accordance with the present invention, wherein a plurality of wires of the cable are disposed on an flatly insulative protecting sheet of the cable.

FIG. 3 is a top view of the cable of FIG. 2, wherein the protecting sheet is wrapped on wires of the cable.

### DETAILED DESCRIPTION OF THE INVENTION

Reference will now be made in detail to a preferred embodiment of the present invention.

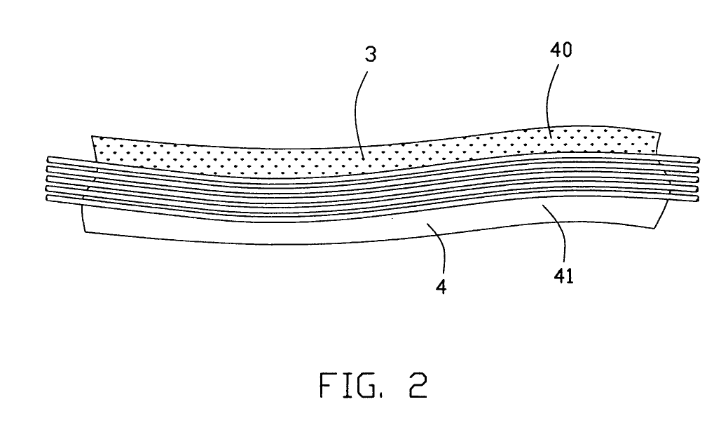

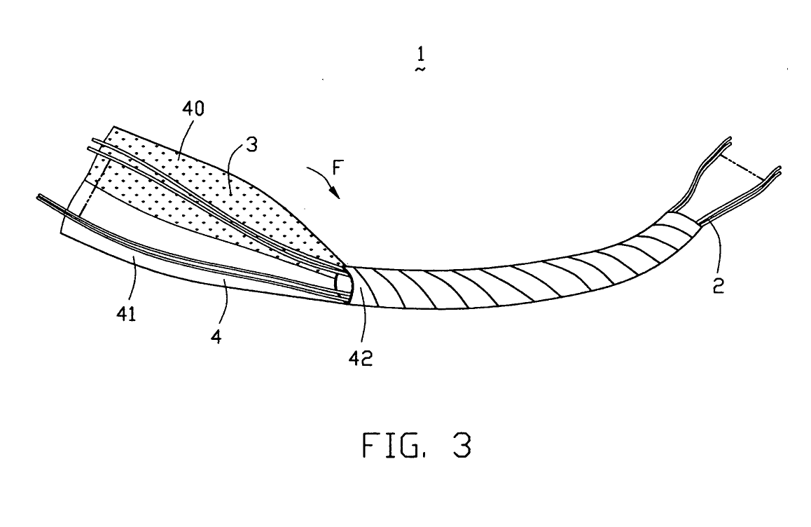

Referring to FIG. 2 and FIG. 3, a cable 1 for a laptop computer (not shown) in accordance with a preferred embodiment of the present invention comprises a plurality of wires 2, an elongate protecting sheet 4 and adhesive material 3 disposed on the protecting sheet 4.

In this embodiment, the wires 2 are micro-coaxial wires and comprise an inner and outer conductors (not shown) separated by an inner dielectric layer (not shown) and surrounded by an outer dielectric layer (not labeled). The wires 2 are loosely arranged in a juxtaposed manner along a longitudinal direction. The protecting sheet 4 is substantially rectangular and defines a longitudinal direction and a transverse direction. The protecting sheet 4 is an insulative sheet, such as an acetic acid sheet. In other embodiments, the protecting sheet 4 may also comprise a conductive layer (not shown) and an insulative layer facing to the wires 2. An elongate part 40 of an inner surface of the protecting sheet 4 is coated with adhesive material 3 along the longitudinal direction. In this embodiment, the area of the part 40 coated with adhesive material 3 occupies less than two thirds of the protecting sheet 4. And a left part 41 of the inner surface and an outer surface 42 of the protecting sheet 4 is not coated with the adhesive material 3.

Referring to FIG. 3, the protecting sheet 4 helically wraps from an end of the wires 2 to the other end of the wires 2. During wrapping process, the part 40 coated with the adhesive material 3 fully pastes on the outer surface 42 of the protecting sheet 4. After the protecting sheet 4 wraps on the wires 2, the wires 2 only face to the clean left part 42 of the inner surface of the protecting sheet 4. Thus the wires 2 are free to the protecting sheet 4. The protecting sheet 4 can provide the wires protection from unexpected force from outside. When the protecting sheet 4 is stagnated by a protruding or a coarse inner surface of a host or a hinge of the laptop computer during opening or closing the laptop computer, the wires 2 can also freely extend the wrapped protecting sheet 4. Thus the wires 2 of the cable 1 will not suffer from the opening or closing action of the laptop computer.

According to above description, a method for making the cable 1 comprises the following steps:
a) providing a plurality of wires 2 and a protecting sheet 4 which includes an inner surface and an outer surface 42 and defines a longitudinal direction and a transverse direction;
b) coating some adhesive material 3 on a part 40 of the inner surface along the longitudinal direction;
c) meandering the protecting sheet 4 to wrap the wires 2 with the part 40 of the inner surface overlapping the outer surface 42, thereby separating the adhesive material 3 from the wires 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cable comprising:
a plurality of conductive wires arranged loosely from one another; and
an elongate protecting sheet having at least an adhesive strip along the sheet;
wherein when the sheet is wrapped along the conductive wires, the conductive wires are untouched by the adhesive strip.

2. The cable as claimed in claim 1, wherein the protecting sheet is helically curved to wrap the cable therein.

3. The cable as claimed in claim 1, wherein the protecting sheet is an acetic acid sheet.

4. The cable as claimed in claim 1, wherein the wires are coaxial wires.

5. The cable as claimed in claim 1, wherein the protecting sheet comprises a conductive layer for shielding the wires and an insulative layer below the conductive layer and facing to the wires.

6. The cable as claimed in claim 1, wherein the adhesive strip is coated on an inner surface of the protecting sheet and occupies less than two thirds of the inner surface.

7. A method of making a cable comprising following steps:
providing a plurality of wires and a protecting sheet which includes an inner surface and an outer surface and defines a longitudinal direction and a transverse direction;
coating some adhesive material on a portion of the inner surface along the longitudinal direction;
meandering the protecting sheet to wrap the wires with the portion coated with adhesive material overlapping on the outer surface of the protecting sheet, thereby separating the adhesive material from the wires.

8. The method of making a cable as claimed in claim 7, wherein the wires are micro-coaxial wires.

9. The method of making a cable as claimed in claim 7, wherein the protecting sheet comprises a conductive layer and an insulative layer.

10. The method of making a cable as claimed in claim 7, wherein the area of the portion coated with the adhesive material is less than two thirds of that of the inner surface of the protecting sheet.

11. A cable comprising:
a plurality of conductive wires arranged loosely with one another;
an elongate soft protecting sheet; and
a conductive adhesive layer applied unto only a portion of an inner surface of the protecting sheet; wherein
the sheet is wrapped along the conductive wires with more than one roll under a condition that the conductive wires directly contact the rest of the inner surface without contamination and said portion are overlapped with an outer surface opposite to said rest.
